(19) United States
(12) Patent Application Publication
(10) Pub. No.: US 2019/0087909 A1
(43) Pub. Date: Mar. 21, 2019

(54) TECHNOLOGY PLATFORM DISPATCH SYSTEM

(71) Applicant: Technology Enhanced Claims Handling, Inc., Palm Beach Gardens, FL (US)

(72) Inventor: Jeffrey B. Scott, Jupiter, FL (US)

(21) Appl. No.: 16/194,905

(22) Filed: Nov. 19, 2018

Related U.S. Application Data
(63) Continuation-in-part of application No. 15/285,069, filed on Oct. 4, 2016.
(60) Provisional application No. 62/308,342, filed on Mar. 15, 2016.

(51) Int. Cl. G06Q 40/08; G06Q 10/06

(52) U.S. Cl. CPC G06Q 40/08; G06Q 10/06311

(57) ABSTRACT

A system, method and program product for dispatching agents. A system is provided that includes: a data processing engine for inputting a claim and creating an opportunity; an agent system interface that provides a communication link and maintains information for a network of agents; a matching system that identifies a set of agents from the network of agents to handle an aspect of the claim; a selection system that broadcasts the opportunity to the set of agents, analyzes responses from the set of agents, and assigns the claim to a selected agent; and a tracking system that monitors performance of the selected agent, and collects feedback regarding the selected agent.

### TECHNICAL FIELD

The subject matter of this invention relates to dispatching agents in a technology based platform such the Internet of Things, and more particularly to a system and method of dispatching opportunities to agents in response to a loss condition.

### BACKGROUND

The ability to efficiently manage assets within a platform of assets plays an increasingly important role in the everyday world, particularly where the assets are interconnected and/or have varying levels of intelligence, e.g., devices within the Internet of Things, autonomous vehicle fleets, smart buildings, client devices, etc. One particular challenge is the ability to efficiently manage and deal with asset loss conditions, in which an asset has suffered some damage, e.g., an operational failure, physical damage, a security failure, etc. One way to streamline the process is to provide assets with the ability to report loss conditions and receive agents to address loss conditions should a loss occur.

When a loss condition is detected at an asset, the ability to address the loss quickly by a stakeholder can greatly reduce the ultimate cost associated with the incurred damage. Namely, the quicker the damage can be contained and assessed by responding agents, the more likely the cost can be contained. Quite often a loss condition associated with an asset may become worse over time (e.g., more and more data may be lost in a storage device if a virus is not contained, physical damage may propagate if not dealt with, etc.). Accordingly, the more effective the response to address the loss condition, the more likely the impact can be contained and costs controlled. Furthermore, the sooner the extent of the damage can be assessed, the less likely fraud or the like can be perpetrated by an entity that controls the asset.

In one approach, when a loss condition is reported, a primary stakeholder can select and dispatch responsive agents necessary to contain and assess the loss. However, because assets and loss conditions differ from situation to situation, containment and assessment may require different types of specialization and capabilities. Accordingly, some agents may be better equipped to deal with the loss than others. Dispatching agents in a limited and/or ad hoc manner will therefore not result in a robust system. For example, the primary stakeholder may have pre-arranged agreements with one or more providers to dispatch agents anytime a loss condition occurs within the platform. Oftentimes however, the dispatched agents are not the best fit to contain or assess the loss condition.

### SUMMARY

Aspects of the disclosure describe an improved technology platform, such as an IoT platform, that can broadcast opportunities to agents in response to a reported loss condition. Agents can thereafter be matched to opportunities and dispatched to assets to address the loss condition. The described approach thus provides a technology improvement for any platform in which assets are managed.

A first aspect discloses an Internet of Things (IoT) platform having an agent dispatch system for handling loss conditions associated with assets in the IoT platform, comprising: a data processing engine that inputs loss information for an asset, interfaces with third party data sources to obtain policy details for the asset, and creates at least one of an assessment opportunity or a containment opportunity; an agent system interface that provides a communication link and maintains information for a network of agents; a system that broadcasts an opportunity comprising at least one of the assessment opportunity and containment opportunity to the set of agents, processes responses from the set of agents, and assigns the opportunity to a selected agent; and a dispatch system that causes the selected agent to be dispatched to the asset.

A second aspect discloses a technology platform having an agent dispatch system for handling loss conditions, comprising: a data processing engine that inputs loss information, interfaces with third party data sources to obtain policy details, and creates at least one of an assessment opportunity or a containment opportunity; an agent system interface that provides a communication link and maintains information for a network of agents; a matching system that identifies a set of matching agents from the network of agents; a selection system that broadcasts an opportunity comprising at least one of the assessment opportunity and containment opportunity to the set of matching agents, processes responses from the set of matching agents, and assigns the opportunity to a selected agent; and an agent performance system that tracks and monitors performance of the selected agent, and collects feedback regarding the selected agent.

A third aspect discloses a computerized method that provides agent dispatching in a technology platform, comprising: inputting an electronic record that details information about a loss condition; interfacing with a third party data source to obtain policy details associated with the loss condition; creating an opportunity that includes at least one of an assessment assignment opportunity or a containment assignment opportunity; identifying a set of matching agents from a network of agents to handle the opportunity; broadcasting the opportunity to the set of matching agents, analyzing responses from the set of matching agents, and assigning the opportunity to a selected agent; and monitoring performance of the selected agent.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a flow diagram of an agent dispatch process in an IoT platform according to embodiments.

FIG. 2 shows a computing system having an agent dispatch system according to embodiments.

FIG. 3 shows a flow diagram of an assessment agent dispatch process according to embodiments.

FIG. 4 depicts a flow diagram of a containment agent dispatch process according to embodiments.

FIG. 5 depicts an illustrative client App interface for initiating a loss process according to embodiments.

FIG. 6 depicts a further client App interface according to embodiments.

FIG. 7 depicts an administrative agent tracking interface according to embodiments.

FIG. 8 depicts an agent availability interface according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

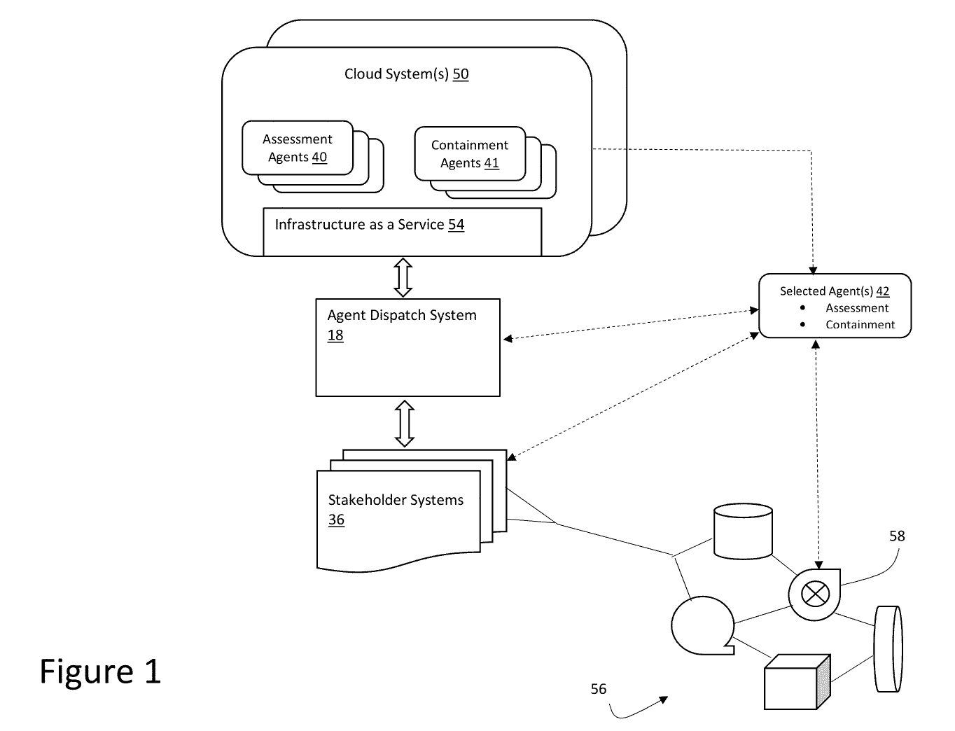

Referring now to the drawings, FIG. 1 depicts an illustrative embodiment of an agent dispatch system 18 that can be used to select and manage agents during a loss condition within the context of a technology platform. In this embodiment, agents generally comprise software that can be selected and dispatched to an Internet of Things (IoT) asset 58. However, for the purposes of this disclosure, agents may comprise, e.g., computerized software agents, virtual world entities, networked applications (Apps) associated with users, humans, or any other form of agent. Apps may comprise, e.g., programs adapted to run on a smart device such as a mobile phone, client software, an SMS application, special purpose hardware, firmware, Java script, bots, mobile agents, etc. A technology platform may comprise any computer based data processing system that tracks, manages or controls one or more aspects of associated assets. Assets may comprise any type of device, system, property, etc.

In this particular embodiment, IoT platform 56 is a network of connected assets, e.g., devices, vehicles, buildings, products, etc., embedded with electronics, software, sensors, location data, and network connectivity that enables these assets to collect and exchange data and processes. The IoT 56 allows assets to be sensed, interrogated and controlled locally via software agents and processes, or remotely across an existing network infrastructure, allowing for control over and/or the direct interrogation of the physical status of each asset. This embodiment may also include one or more cloud systems 50 that store agents that can be accessed using an Infrastructure as a Service (IaaS) 54 interface.

In this example, assets in the IoT platform 56 may be protected by stakeholder systems 36 that are implemented to handle loss conditions. For example, assets may be insured, or have components that are insured by one or more stakeholder systems 36. For example, a smart building may have indemnification to cover damage resulting from a storm and include sensors, cameras, and other equipment to detect damage, such as flooding, equipment failure, etc.; an autonomous automobile may have insurance to cover accidents; a smart appliance may have warranty coverage to insure against product failure; a power turbine may have insurance to cover failure, etc. If a loss condition is detected at an IoT asset 58, the asset 58 may include a program to record the loss (e.g., via video data, sensor data, etc.) and programmatically notify an associated stakeholder system 36. The notice may include a claim that a repair is required and/or a request for service to immediately address an emergency situation.

The stakeholder system 36 then in turn processes and forwards the claim and/or request to the agent dispatch system 18 to select and dispatch one or more selected agents 42 to the asset. In the case where a repair is required, an assessment agent 40 is selected from a cloud system 50 and dispatched to the asset 58 to assess the damage, e.g., determine to cost to repair the asset. Additionally, if emergency service is required, a containment agent 41 is selected from a cloud system 50 and dispatched to the asset 58 to provide emergency service.

Agent dispatch system 18 does not simply select agents 38 in an ad hoc manner, but instead broadcasts the opportunity to a number of participating agents that can in turn accept or decline the opportunity based, e.g., on their capabilities. Agent dispatch system 18 can then evaluate different agents 38 that have signaled a desire to accept the opportunity, e.g., based on the type of claim, past performances, preferences, etc. For example, in response to a smart building that was flooded, agent dispatch system 18 can broadcast an opportunity involving the loss condition, select a responding agent having the necessary resources (i.e., programs) to interface with a smart building to interrogate its condition, and cause the selected agent 42 to be dispatched. The selected agent 42 may be dispatched to the asset 58 over a network and be installed at the site on an internal computing system to interrogate the asset 58. For example, sensors can be checked, image data can be evaluated, systems can be tested, reports can be analyzed, questions can be generated, etc. Alternatively, the interrogation process may be done remotely by sending and receiving data. Based on the interrogation, the selected assessment agent 42 can report back to one or both of the stakeholder system 36 or agent dispatch system 18.

In the case where an emergency situation is reported, a containment agent 41 can be selected in a similar fashion. For example, if a critical part on a large smart machine failed and caused the machine to overheat, agent dispatch system 18 would broadcast the opportunity, select a responding containment agent 41, and cause the agent to be dispatched to the asset 58 to, e.g., shut down subsystems, engage a fire sprinkler, order replacement parts, etc.

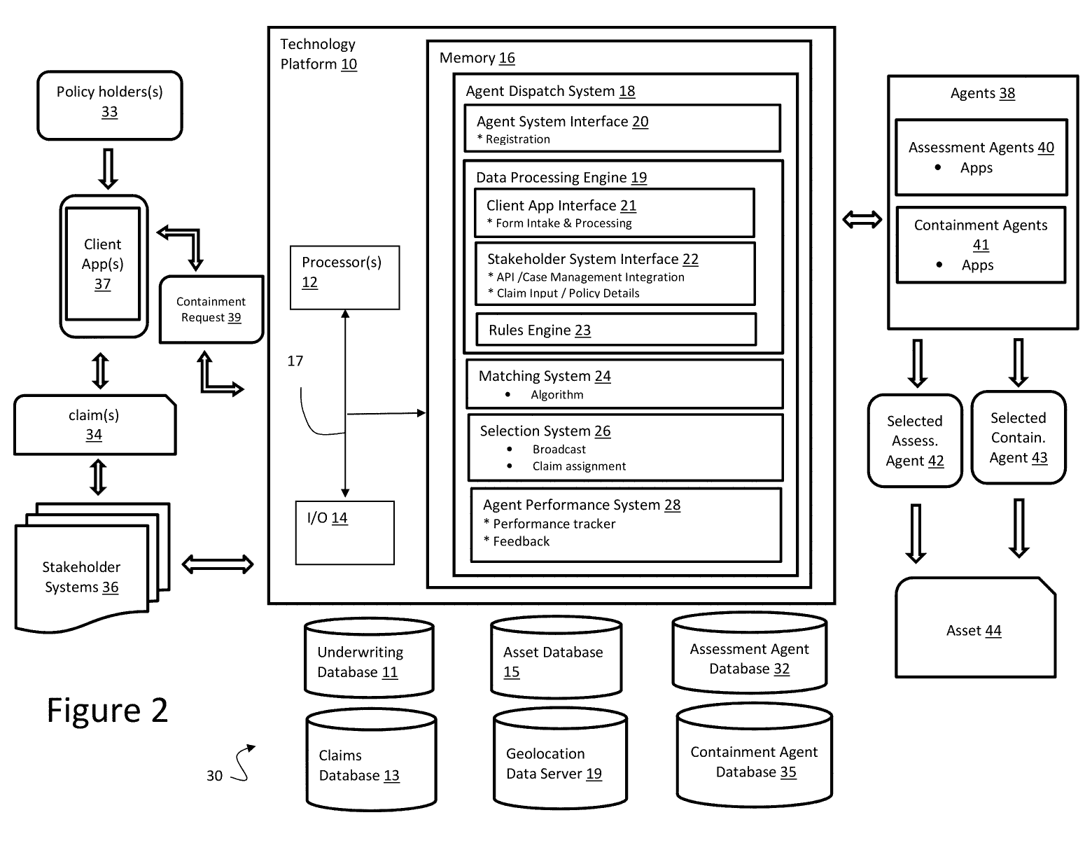

FIG. 2 depicts a technology platform 10 for implementing an agent dispatch system 18 that facilitates dispatch of agents 38 to an asset 44 in response to a loss condition submitted as, e.g., a claim 34 or containment request 39. Technology platform 10 is intended to be “application agnostic” in that the platform can be utilized in any scenario in which protected assets 44 are subject to claims 34 that require assessment and/or containment, e.g., IoT platforms, autonomous vehicle fleets, robot/drone systems, smart infrastructures, insurance infrastructures, etc. Assessment generally refers to evaluating the loss condition to determine repair or replacement costs. Containment generally refers to actions taken to limit further damage to the asset. The technology platform may also be utilized to effectuate repairs to the asset.

To provide this functionality, agent dispatch system 18 interfaces on the back end with a network of agents 38, including assessment agents 40 and containment agents 41 via a communication channel that may, e.g., include a client-server platform, smart devices, wireless Apps, SMS devices, cell phones, etc. The network of agents 38 may include independent entities not controlled and/or employed by a stakeholder system 36 and/or agents that are employed or controlled by a stakeholder system 36. As noted, agents 38 may comprise, e.g., computerized software agents, virtual world entities, real world human adjusters having access to a networked device, emergency service providers, or any other form of agent. Associated agent Apps may comprise, e.g., programs adapted to run on a smart device such as a mobile phone, client software, an SMS application, special purpose hardware, firmware, Java script, bots, mobile agents, etc. Stakeholder systems 36 generally comprise entities that are responsible for loss conditions associated with the assets 44, e.g., they insure assets 44, etc. Stakeholder systems 36 may for example enter into agreements with policy holders 33 that dictate the types of protection that will be afforded to the asset 44 in the event of a loss condition. Policy holders 33 may include the asset itself, asset owners, entities responsible for the asset, other assets, etc.

When a loss condition occurs, a policy holder 33 initiates the process using, e.g., a client App 37 or system that allows the policy holder 33 to submit loss information, and create a claim 34 and/or a containment request 39 with the stakeholder system 36 or directly with agent dispatch system 18. In the case of an IoT asset, the client App 37 may comprise code embedded in the asset capable of automatically collecting and reporting loss information. In other cases, the client App 37 may comprise an App on a smart device, a Web interface, etc.

In one embodiment, different versions of client App 37 may be affiliated and coupled with different stakeholder systems 36. Thus, policy holders 33 of different stakeholder systems 36 would utilize the client App 37 (or other communication mechanism) specifically tailored to their respective stakeholder system 36. In this manner, policy details can be readily retrieved as needed for policy holders 33. In one embodiment, stakeholder systems 36 push data to the agent dispatch system 18 when a claim 34 is received by one of the stakeholders systems 36 based on loss information reported by a policy holder 33. In another embodiment, agent dispatch system 18 pulls data from the appropriate stakeholder system 36 when loss information is reported to the agent dispatch system 18. Stakeholder system 36 may for example include a third party claims management system and/or a claim assignment management system. Initiation of the process may also occur via other communication channels, e.g., SMS requests, telephone, etc.

Stakeholder systems 36 may comprise, e.g., traditional policy and/or claims management systems that track and manage claims, automated warranty systems connected to a network of smart devices, adjuster assignment management systems, or any other type of process or system capable of managing claims.

As part of the described process, agent dispatch system 18 may interface with a set of disparate data sources 30, which may include various third party legacy databases associated with stakeholder systems 36. Although shown stored with technology platform 10, it is understood that certain data sources 30 may reside in different physical locations and be controlled by other entities (such as the Comprehensive Loss Underwriting Exchange, stakeholder system databases, etc.).

In this illustrative embodiment, data sources 30 utilized by agent dispatch system 18 may include: an underwriting database 11, a claims database 31 that tracks reported losses by policy holders, e.g., with a claim ID; a policy holder database 15 that provides, e.g., location information for the policy holder; an assessment agent database 32 that details participating adjusters; a containment agent database 35 that details participating emergency service providers; and a geolocation data server 19 that tracks the location of active agents 38.

Agent dispatch system 18 generally includes: an agent system interface 20 that provides a communication link with assessment agents 40 and containment agents 41; a data processing engine 19 that receives loss information, interfaces with various data sources 30 including third party legacy data sources, and creates opportunities; a matching system 24 that matches a submitted claim 34 or containment request 39 with a set of (i.e., one or more) matching assessment agents 40 and/or containment agents 41 from the network of agents 38; a selection system 26 that (1) broadcasts opportunities to matching assessment agents 40 and/or containment agents 41; (2) processes agent responses; and (3) determines a selected assessment agent 40 and/or containment agent 41 to handle the opportunity. Also included in agent dispatch system 18 is an agent performance system 28 that tracks, manages, and collects feedback for agents 38 that have been dispatched to handle a loss condition.

In this embodiment, agent system interface 20 provides a communication link between the agent dispatch system 18 and Apps 37 associated with assessment agents 40 and containment agents 41 in a network. Data may for example be transmitted back and forth using any known transmission protocol, e.g., a web-based HTML protocol, SMS, etc. In one embodiment, agents 38 may be required to first register with the agent dispatch system 18 via the agent system interface 20 in order to participate in the network. Registration may for example include providing contact information, location data, device information, references, experience, expertise, creating login and password information, etc. Once registered, agent information may be stored in the assessment agent database 32 or the containment agent database 35.

As noted, data processing engine 19 is responsible for receiving loss information, interfacing with various data sources 30, and generating opportunities for agents 38. A client App interface 21 provides a communication link with client Apps 37, which can for example receive loss information such as containment requests 39. Loss information may be received via an electronic form. Also provided is a stakeholder system interface 22 that provides a communication link with stakeholder systems 36 (and their legacy data sources) for obtaining policy details, claim information, etc., as needed.

Client App interface 21 may for example utilize a web-based form that the policy holder can fill out and submit. The form collects as much loss information as possible from the policy holder 33, and then relies on a rules engine 23 to further populate the form and/or initiate the dispatch process. For example, the rules engine 23 may ping various data sources 30 to determine policy coverage from an asset database 15 (e.g., is there a valid policy in place?), obtain location and contact information of the policy holder, etc. Based on the information entered, the rules engine 23 may present additional queries or information to the policy holder 33 for the dispatch process.

Stakeholder system interface 22 may for example be implemented with an application programming interface (API) that allows third party stakeholder systems 36 to exchange data with the agent dispatch system 18. The API specification may for example be implemented with Microsoft APIs, Java APIs, or any other suitable specification. Using the API, stakeholder systems 36 can automatically or manually submit loss information, claims 34 or containment requests 39 to the agent dispatch system 18. The stakeholder system interface 22 may also integrate with existing claims management systems and claim assignment management systems utilized by the stakeholder systems 36, and be implemented to accept claims in a standard industry format, e.g., as provided by ACORD, (Association for Cooperative Operations Research and Development), ISO, IVANS etc. Stakeholder information, such as company data, submitted claims, policy information, assignment information, etc., may be stored in stakeholder legacy databases, such as claims database 13.

Alternatively, loss information may be submitted to the agent dispatch system 18 manually via a user interface either by an insurance entity or directly by the policy holder 33.

### Agent Dispatch

Once sufficient loss information and/or a claim 34 is submitted either directly or via the stakeholder system interface 22, an opportunity is generated by the data processing engine 19, and the matching system 24 immediately identifies a set of matching assessment agents 40 best adapted to assess the claim 34 based on a matching algorithm. For example, if the claim 34 involves a particular type of loss at a determined location or for a particular asset class, the algorithm will identify assessment agents 40 having the best set of attributes to evaluate the claims, e.g., experience with that type of loss and/or which are near the determined location. In the case where the loss involves a device in the Internet of Things, the matching algorithm will attempt to identify assessment agents 40 that have the resources (e.g., program code) to evaluate the particular loss and meet any necessary requirements, e.g., ones that have the appropriate security clearance, are an approved provider, etc. In the case where the loss involves real property, the matching algorithm will attempt to identify adjusters that are nearby and have experience.

Once a set of matching assessment agents 40 are identified, selection system 26 broadcasts the opportunity to the matching assessment agents 40. The opportunity may for example be broadcast via: SMS text messaging, a cellular network, assessment agent Apps, the World Wide Web, an open cloud computing interface that supports Infrastructure, Platform and/or Software as a Service, etc. The opportunity may be broadcast sequentially to a list of matching agents based on a ranking until one accepts the opportunity. Alternatively, the opportunity may be broadcast to a batch of matching agents at the same time and a selection from those accepting the opportunity can be made.

The assessment opportunity may include various requirements, such as a required response time and cost parameters, etc. For example, any matching assessment agents 40 interested in accepting the opportunity may be required to respond back within 10 minutes, be installed and/or arrive at the loss site by a certain time and be willing to perform the claim assessment for a predetermined fee.

Accordingly, any of the matching assessment agents 40 who receive the broadcast and can meet any requirements can respond indicating a desire to accept the opportunity (or respond declining the opportunity). The response may similarly be communicated via: FTP, SMS text messaging, a cellular network, adjuster Apps, the World Wide Web, an open cloud computing interface that supports Infrastructure, Platform and/or Software as a Service, etc. The response may optionally include information such as an estimated time to arrive at an asset 44, an estimated time to complete a claim adjustment, a cost to complete, potential issues or conflicts, any relevant knowledge, capabilities or expertise possessed by the agent, etc.

Once one or more responses are received, the selection system 26 determines a selected assessment agent 42 to handle the claim 34. Selection may be made on a first received basis, based on a rank determined by the matching algorithm, or any other basis. Once a final selection is determined, an agent assignment is made and is recorded in both the claims database 13 and assessment agent database 32 assigning the claim 34 (or potential claim) to the selected assessment agent 42 who then is tasked with evaluating the claim 34.

Once a selected assessment agent 42 is determined and assigned to the claim 34, agent performance system 28 may be implemented to monitor and track the performance of the claim assessment and generate any necessary reports and information, e.g., status messages can be generated back to the stakeholder system 36, back to the policy holder 33, back to the selected assessment agent 42, etc. For example, the policy holder 33 may be notified via a text message of an identity and expected install or arrival time of the selected assessment agent 42. The stakeholder system 36 may be notified of the progress, e.g., when did the selected assessment agent 42 arrive at the asset 44, was the assessment completed, etc. In addition, feedback may be collected from any or all of the parties, e.g., the policy holder 33 may provide feedback regarding the selected assessment agent 42; the selected assessment agent 42 may provide feedback regarding the claim 34, policy holder 33, asset 44 or insurance company; the stakeholder system 36 may provide feedback regarding the timeliness and accuracy of the selected assessment agent 42. Feedback information for a claim 34 may be stored in the claims database 13, agent database 32, 35 and/or be provided to the associated stakeholder system 36.

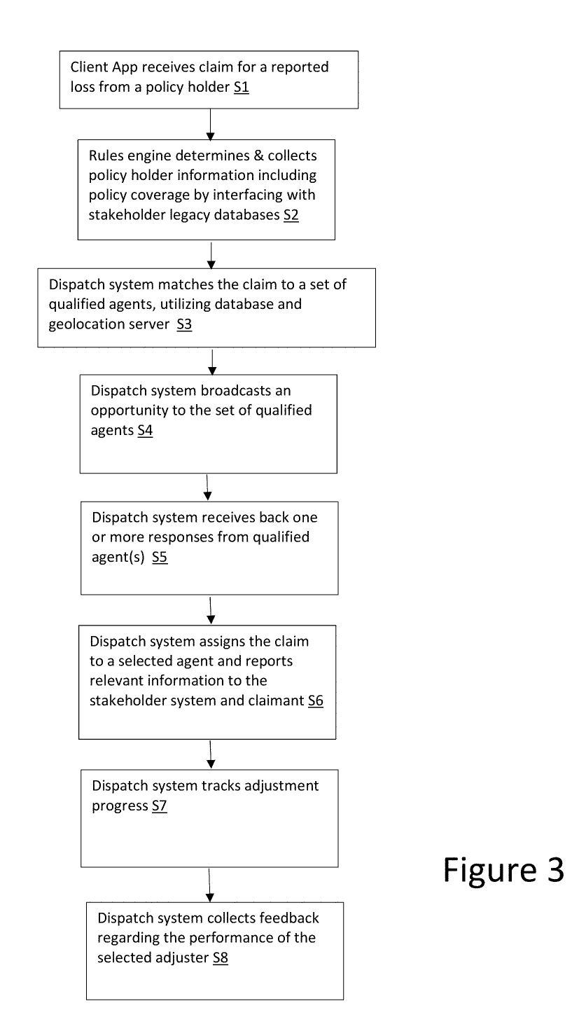

FIG. 3 depicts a flow diagram of an illustrative process for implementing the agent dispatch system 18 of FIG. 2 when an assessment agent is required. As noted, and assessment agent may be any software process, proxy, App, adjuster, etc., capable of evaluating a loss condition of an asset. At S1, a policy holder 33 for a participating stakeholder system 36 enters loss and/or claim information into the client App 37 for a loss condition. At S2, the rules engine 23 determines and collects policy holder information including policy coverage type and form (e.g., wind only, HO3, OP3, etc.) by interfacing with stakeholder legacy databases. This may also include submitting the claim 34 to the participating stakeholder system 36. Next, the agent dispatch system 18 matches the claim 34 to a set of matching assessment agents 40 at S3. For example, the claim 34 may be matched based on geolocation, resources, expertise, timing, cost, preference, etc. Once a matching set of assessment agents 40 are determined, the assessment opportunity is broadcast to the set of matching assessment agents at S4 and at S5 one or more responses are received back. At S6, the agent dispatch system 18 assigns the claim to a selected assessment agent 42 based on a predetermined criteria and reports back the relevant information to the stakeholder system 36, policy holder 33, etc. Next at S7 the agent dispatch system 18 tracks the assessment progress, e.g., by entries made into an assessment App, based on a location of the assessment agent, based on inquiries from the policy holder 33, etc. Once complete, the agent dispatch system 18 collects performance feedback at S8, which is stored and can be used for future assessment agent selections.

### Containment Agent Dispatch

Similarly, when a containment request 39 is entered, either directly from the policy holder 33 (e.g., via the client App 37) or from a respective stakeholder system 36, a containment opportunity is generated by the data processing engine 19, and matching system 24 identifies a set of matching containment agents 41 capable of handling the emergency situation (e.g., security breach, error, flood, fire, accident, etc.). Selection system 26 broadcasts the opportunity to the set of matching containment agents 41, and a selection is made based on predefined criteria, e.g., which agent responds first, which agent is closest, which agent has the most experience, best rating, etc. Once selected, the opportunity is assigned to the selected containment agent 43 and the agent tracking system 28 tracks the progress of the containment agent.

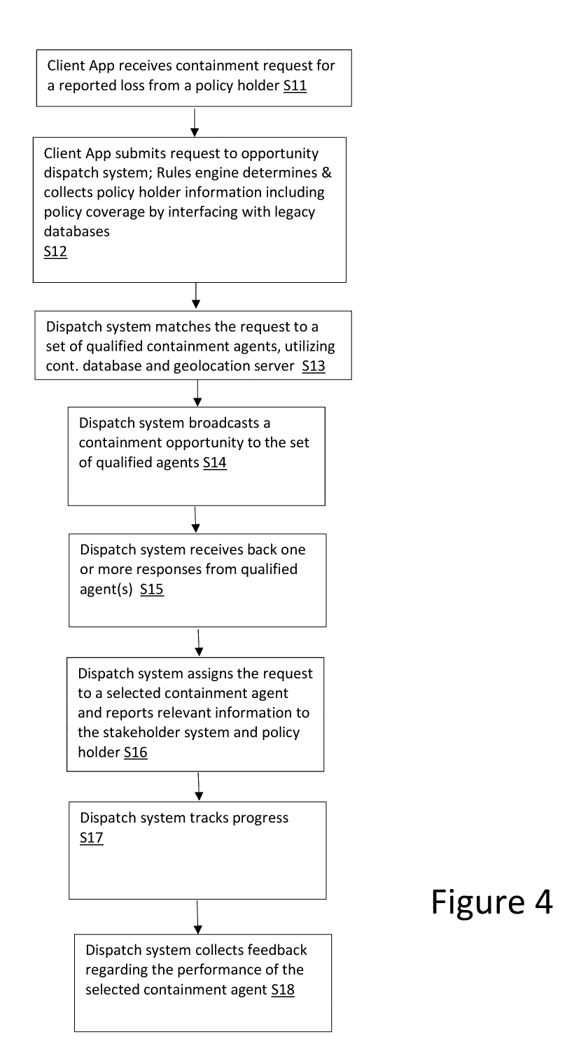

FIG. 4 depicts a flow diagram of an illustrative process for implementing the agent dispatch system 18 of FIG. 2 when a containment agent 41 is required. A containment agent 41 may for example comprise software code that can be installed and run within an asset to limit damage, an emergency service provider that can physically go to an asset to reduce the harm, etc. At S11, client App 37 receives a containment request 39 for a reported loss from a policy holder 33 and at S12, the client App 37 submits the containment request to the agent dispatch system 18.

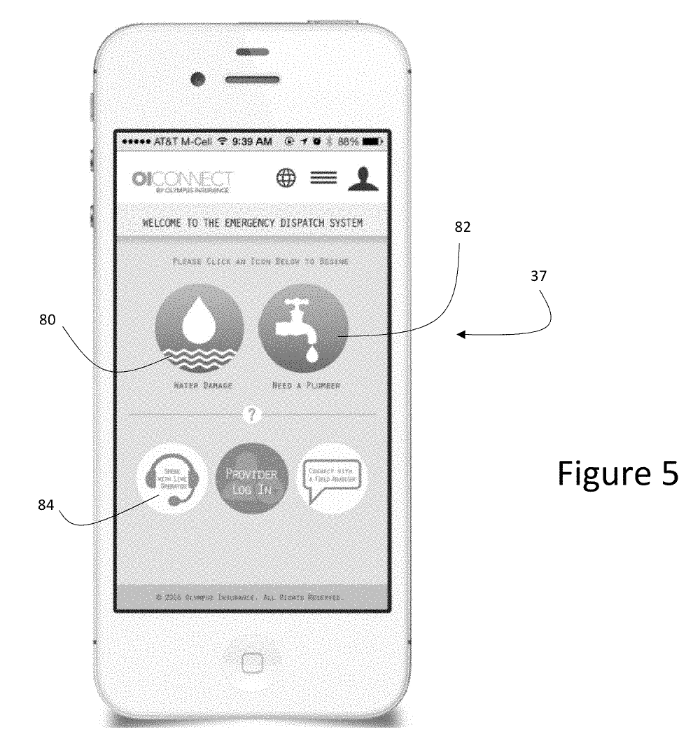

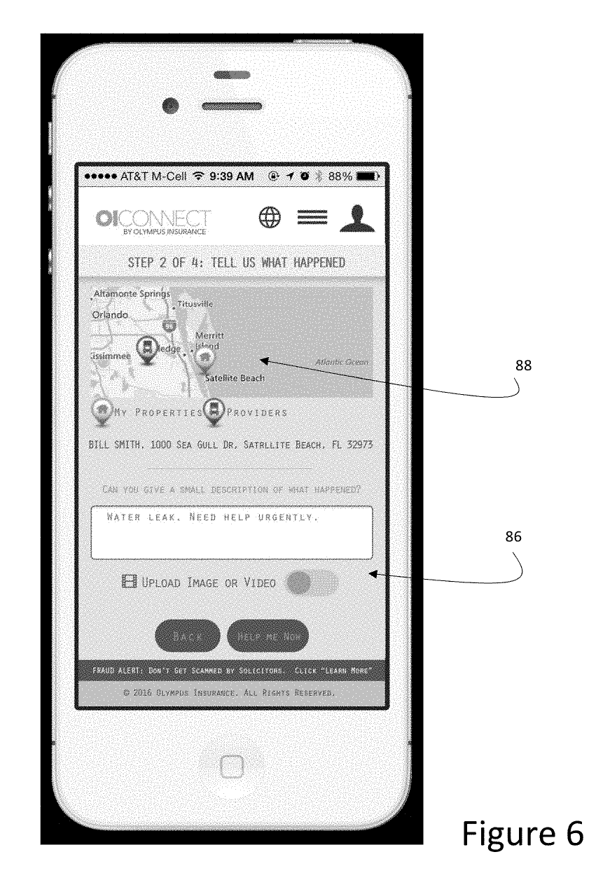

For example, FIG. 5 depicts an interface for a client App 37 that allows the policy holder 33 to manually report an emergency water damage situation 80, request a plumber 82 or directly speak with stakeholder representative 84. From that point, loss information about the policy holder 33 can be collected by the rules engine 23, including the address of the loss either based on stored information, coverage information, information derived from a location service such as GPS, phone number, or entered information. The client App 37 may also attempt to retrieve policy information at this point from the stakeholder system. Information about the loss can also be uploaded 86, e.g., via text, pictures, video, etc., and the location 88 of the loss and any nearby providers can be displayed, as shown in FIG. 6.

Next, the agent dispatch system 18 matches the containment request 39 to a set of qualified containment agents at S13 and reports the process back to the client App 37. For example, the containment request may be matched based on location, resources, expertise, timing, etc. Once a matching set of containment agents 41 are determined, the containment opportunity is broadcast to the set of qualified containment agents 41 at S14 and at S15 one or more responses are received back. At S16, the agent dispatch system 18 assigns the containment opportunity to a selected containment agent 43 based on a predetermined criteria and reports back the relevant information to the stakeholder system 36, policy holder 33, etc. This may be done via a text message or via any other notification protocol. Next at S17 the agent dispatch system 18 tracks the containment progress, e.g., by entries made into an App, based on a located of the containment agent, based on inquiries from the policy holder 33, etc. This information may be reported back to the client App 37, e.g., in the form of a map. Once complete, the agent dispatch system 18 collects performance feedback at S18, which is stored and can be used for future containment agent selections, as well as cost calculators (e.g., labor hours based on time at the loss site), and actuarial loss estimating and rate making.

Captured claims may include various information such as claim number, cause and description, policy information, insured (claimant) information, and contact information. A priority indicator may also be included that determines how urgent the claim is, e.g., on a scale, yes/no, etc. Once the claim 34 is captured by the agent dispatch system 18, it is transformed into an adjustment opportunity. The adjustment opportunity may for example be stored in an XML file that includes all of the information in the claim 34, as well as any requirements such as a location radius around the loss site, cost parameters, expertise requirements, etc.

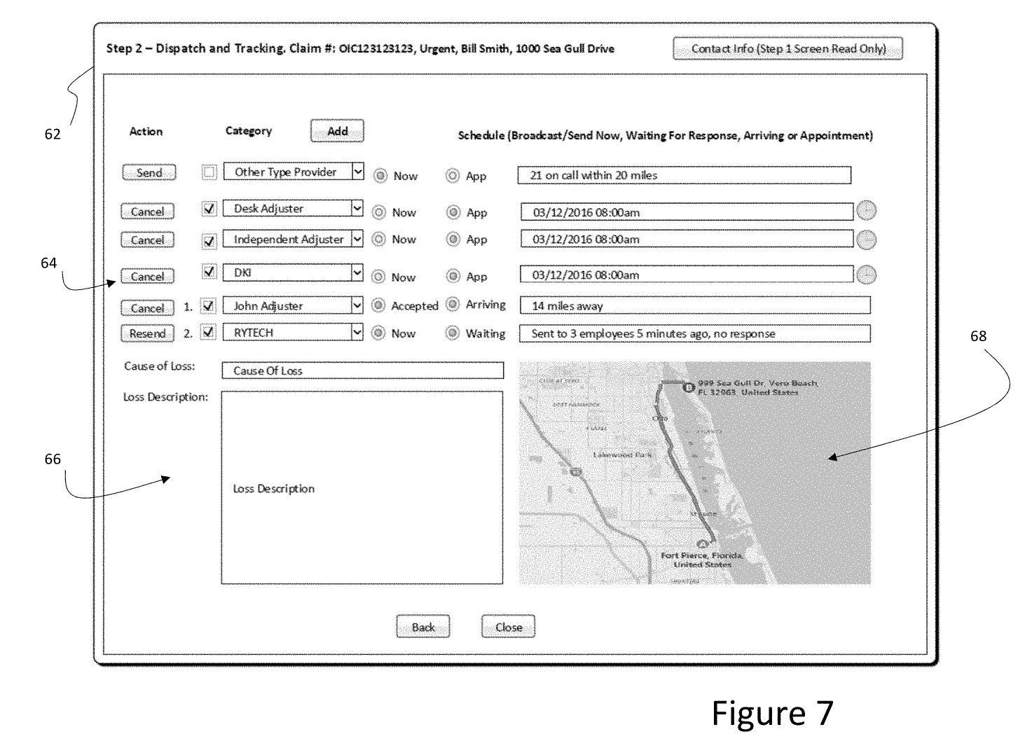

FIG. 7 depicts an illustrative dispatch and tracking dashboard 62 that details a set of matching assessment agents 64, including action, category and schedule data. In this case, “John Adjuster” accepted the adjuster opportunity and is 14 miles away. The dashboard 62 allows the selection process to be viewed by an administrator associated with the adjuster dispatch system 18. Also shown in the dashboard 62 is the associated loss information 66 and a map 68 of the loss site and location of a selected adjuster agent.

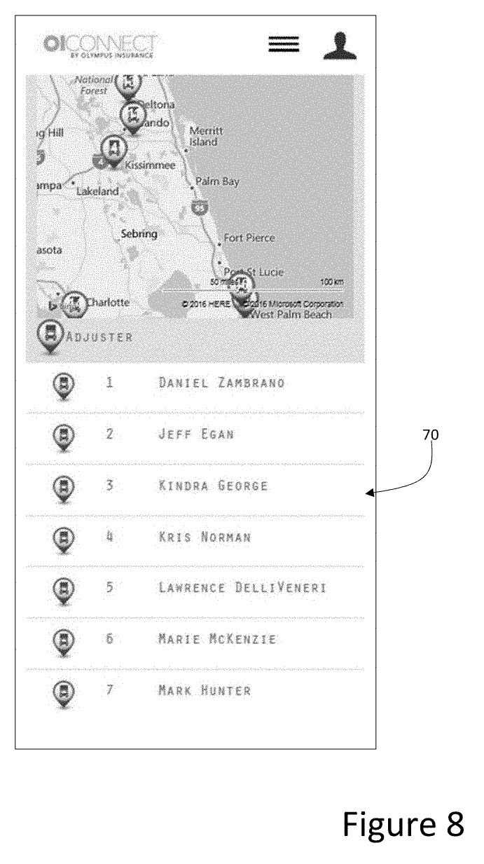

FIG. 8 depicts a further dashboard interface that shows a set of agents 70 that were identified by a matching algorithm for a received claim. Each of the matched agents are also depicted on a map to show proximity to a loss site. Each of these agents are associated with an actual person, e.g., an insurance adjuster. In an alternative embodiment, the set 70 may comprise various software agents capable of fulfilling the opportunity.

It is understood that agent dispatch system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Technology platform 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in platform 10. I/O 14 can comprise one or more human I/O devices, which enable a user to interact with computing system 10. Computing system 10 may also be implemented in a distributed manner such that different components reside in different physical locations.

Furthermore, it is understood that the agent dispatch system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An Internet of Things (IoT) platform having an agent dispatch system for handling loss conditions associated with assets in the IoT platform, comprising:
a data processing engine that inputs loss information for an asset, interfaces with third party data sources to obtain policy details for the asset, and creates at least one of an assessment opportunity or a containment opportunity;
an agent system interface that provides a communication link and maintains information for a network of agents;
a system that broadcasts an opportunity comprising at least one of the assessment opportunity and containment opportunity to the set of agents, processes responses from the set of agents, and assigns the opportunity to a selected agent; and
a dispatch system that causes the selected agent to be dispatched to the asset.

2. The IoT platform of claim 1, wherein the network of agents comprise software agents.

3. A technology platform having an agent dispatch system for handling loss conditions, comprising:
a data processing engine that inputs loss information, interfaces with third party data sources to obtain policy details, and creates at least one of an assessment opportunity or a containment opportunity;
an agent system interface that provides a communication link and maintains information for a network of agents;
a matching system that identifies a set of matching agents from the network of agents;
a selection system that broadcasts an opportunity comprising at least one of the assessment opportunity and containment opportunity to the set of matching agents, processes responses from the set of matching agents, and assigns the opportunity to a selected agent; and
an agent performance system that tracks and monitors performance of the selected agent, and collects feedback regarding the selected agent.

4. The technology platform of claim 3, wherein the data processing engine includes an application programming interface (API) that integrates with third party claim management systems.

5. The technology platform of claim 3, wherein the opportunity is broadcast over a network that utilizes at least one of: a text message, an email, or a mobile application.

6. The technology platform of claim 3, wherein the network of agents comprise software agents.

7. The agent dispatch system of claim 3, wherein the matching system includes an algorithm that ranks the set of agents based on proximity to a location of a type of loss associated with the opportunity.

8. The agent dispatch system of claim 7, wherein the algorithm further ranks the set of agents based on at least one of: cost, experience, prior feedback, or expertise.

9. The agent dispatch system of claim 3, wherein the opportunity includes an associated priority level.

10. The agent dispatch system of claim 1, wherein the data processing engine includes an application programming interface (API) that interfaces with a third party claims assignment management system.

11. A computerized method that provides agent dispatching in a technology platform, comprising:
inputting an electronic record that details information about a loss condition associated with an asset;
interfacing with a third party data source to obtain policy details associated with the loss condition;
creating an opportunity that includes at least one of an assessment assignment opportunity or a containment assignment opportunity;
identifying a set of matching agents from a network of agents to handle the opportunity;
broadcasting the opportunity to the set of matching agents, analyzing responses from the set of matching agents, and assigning the opportunity to a selected agent; and
monitoring performance of the selected agent.

12. The computerized method of claim 11, further comprising providing an application programming interface (API) that integrates with the third party data source, wherein the third party data source includes a claims management system.

13. The computerized method of claim 11, wherein the opportunity is broadcast over a network that utilizes at least one of: a text message, an email, or a mobile application.

14. The computerized method of claim 11, wherein the network of agents comprise one of software agents, adjusters, and emergency service providers.

15. The computerized method of claim 14, further comprising using an algorithm to rank the set of matching agents based on proximity to a site of a loss associated with a claim.

16. The computerized method of claim 11, wherein the algorithm further ranks the set of matching agents based on at least one of: cost, experience, prior feedback, or expertise.

17. The computerized method of claim 11, further comprising providing an application programming interface (API) that integrates with a third party claim assignment management system.

18. The computerized method of claim 11, wherein an asset include one of: a device, a system, personal property or real property.

19. The computerized method of claim 11, wherein technology platform comprises one of a IoT platform, a data processing platform, or an insurance platform.
